(19) United States
(12) Patent Application Publication
(10) Pub. No.: US 2018/0321607 A1
(43) Pub. Date: Nov. 8, 2018

(54) CURABLE LIQUID DEVELOPER

(71) Applicant: CANON KABUSHIKI KAISHA, Tokyo (JP)

(72) Inventors: Akifumi Matsubara, Narashino-shi (JP); Yuzo Tokunaga, Chiba-shi (JP); Naohiko Tsuchida, Abiko-shi (JP); Yasutaka Akashi, Yokohama-shi (JP)

(21) Appl. No.: 15/963,151

(22) Filed: Apr. 26, 2018

(30) Foreign Application Priority Data
May 2, 2017 (JP) 2017-091510

(51) Int. Cl. G03G 9/135; G03G 9/13; G03G 9/125

(52) U.S. Cl. CPC G03G 9/135; G03G 9/125; G03G 9/131

(57) ABSTRACT

A curable liquid developer containing a radical-polymerizable liquid monomer, a photopolymerization initiator, a toner particle being insoluble in the radical-polymerizable liquid monomer, and an amine compound, wherein the amine compound contains an amino group and at least one group selected from the group consisting of an alkyl group having at least 6 carbon atoms, a cycloalkyl group having at least 6 carbon atoms, an alkylene group having at least 6 carbon atoms and a cycloalkylene group having at least 6 carbon atoms, and an amine value of the amine compound is at least 2 mg KOH/g and not more than 200 mg KOH/g.

### BACKGROUND OF THE INVENTION

### Field of the Invention

The present invention relates to a curable liquid developer able to be used in an image forming apparatus that uses an electrophotography system, such as an electrophotography method, an electrostatic recording method or electrostatic printing.

### Description of the Related Art

An electrophotography system is a method for obtaining a printed material by uniformly charging the surface of an image-bearing member such as a photosensitive member (a charging step), forming an electrostatic latent image by exposing to the surface of the image-bearing member to light (an exposure step), developing the formed electrostatic latent image with a developer comprising colored resin particles (a developing step), transferring the developer image to a recording medium such as a paper or a plastic film (a transfer step), and fixing the transferred developer image (a fixing step).

In such cases, developers are broadly classified into dry developers, in which colored resin particles constituted from a material containing a colorant such as a pigment and a binder resin are used in a dry state, and liquid developers, which are obtained by dispersing colored resin particles in an electrically insulating liquid.

In recent years, requirements relating to colorization and high-speed printing have increased for image forming apparatuses such as copiers, fax machines and printers that use electrophotography systems.

Because high-resolution high-quality images are required for color printing, there is a need for developers which can form high-resolution high-quality images and which enable high-speed printing.

Liquid developers are known as developers that are advantageous in terms of reproducibility of color images. Because colored resin particles in liquid developers are unlikely to aggregate during storage, ultrafine toner particles can be used. Therefore, liquid developers can readily achieve excellent characteristics in terms of reproducibility of fine line images and reproducibility of gradation.

There has been extensive development of high-image quality high-speed digital printing apparatuses that use electrophotography techniques involving the use of liquid developers that utilize these excellent characteristics. Under these circumstances, there is a need to develop liquid developers having superior characteristics.

Developers obtained by dispersing colored resin particles in an electrically insulating liquid such as a hydrocarbon-based organic solvent or a silicone oil were known in the past as liquid developers. However, an image quality can significantly deteriorate if the electrically insulating liquid remains on a recording medium such as paper and a plastic film, and it was therefore necessary to remove the electrically insulating liquid.

Electrically insulating liquids are generally removed by applying heat energy so as to volatilize the electrically insulating liquid. In such cases, however, this was not necessarily desirable from perspectives such as the possibility of organic solvent vapor being discharged to outside the apparatus, requiring large amounts of energy and considerations relating to the environment and energy saving.

Methods for curing electrically insulating liquids by photopolymerization have been proposed as countermeasures.

Developers obtained by using monomers or oligomers having reactive functional groups as electrically insulating liquids and dissolving a photopolymerization initiator therein are used as photocurable liquid developers.

Moreover, such photocurable liquid developers are cured by causing reactive functional groups to react when irradiated with light such as ultraviolet radiation, and can be used for high-speed printing.

This type of photocurable liquid developer has been proposed in Japanese Unexamined Patent Application Publication No. 2003-57883. Japanese Unexamined Patent Application Publication No. 2003-57883 discloses an acrylate monomer such as a urethane acrylate as a monomer having a reactive functional group.

In addition, Japanese Unexamined Patent Application Publication No. 2002-274004 discloses an ink composition that contains a polymerization accelerator containing an amine compound.

### SUMMARY OF THE INVENTION

In cases where a radical-polymerizable monomer such as an acrylate monomer is used as a photopolymerizable liquid, as disclosed in Japanese Unexamined Patent Application Publication No. 2003-57883, it is known that if oxygen is present in the monomer, secondary reactions caused by oxygen occur, which hinder polymerization.

In order to prevent hindrance of polymerization by oxygen, Japanese Unexamined Patent Application Publication No. 2002-274004 proposes adding a specific amine compound as a polymerization accelerator. This amine compound traps hydroperoxyl radicals derived from oxygen, which hinder polymerization, and can therefore improve the photopolymerizability of the radical-polymerizable monomer.

In such liquid developers, however, in cases where an amine compound such as that used in Japanese Unexamined Patent Application Publication No. 2002-274004 is used, the volume resistivity of the liquid developer decreases, leading to concerns regarding problems such as reduced image density and defects such as image blurring.

The present invention provides a curable liquid developer that solves the problems mentioned above.

More specifically, the present invention provides a curable liquid developer by which high image density can be achieved, which is unlikely to cause image blurring and which exhibits sufficient fixing performance.

The present invention is

a curable liquid developer comprising a radical-polymerizable liquid monomer, a photopolymerization initiator, a toner particle being insoluble in the radical-polymerizable liquid monomer, and an amine compound, wherein

the amine compound contains an amino group and at least one group selected from the group consisting of an alkyl group having at least 6 carbon atoms, a cycloalkyl group having at least 6 carbon atoms, an alkylene group having at least 6 carbon atoms and a cycloalkylene group having at least 6 carbon atoms, and

an amine value of the amine compound is at least 2 mg KOH/g and not more than 200 mg KOH/g.

Further features of the present invention will become apparent from the following description of exemplary embodiments.

### DESCRIPTION OF THE EMBODIMENTS

In the present invention, numerical ranges shown as “at least AA and not more than BB” and “AA to BB” mean numerical ranges that include the upper and lower limits, unless explicitly stated otherwise.

In addition, monomer unit means that a monomer substance in a polymer or resin is in a reacted state.

The curable liquid developer of the present invention (hereinafter referred to simply as a liquid developer in some cases) is

a curable liquid developer containing a radical-polymerizable liquid monomer, a photopolymerization initiator, a toner particle being insoluble in the radical-polymerizable liquid monomer, and an amine compound, wherein

the amine compound contains an amino group and at least one group selected from the group consisting of an alkyl group having at least 6 carbon atoms, a cycloalkyl group having at least 6 carbon atoms, an alkylene group having at least 6 carbon atoms and a cycloalkylene group having at least 6 carbon atoms, and

an amine value of the amine compound is at least 2 mg KOH/g and not more than 200 mg KOH/g.

It is surmised that the reason why the present invention can solve the problems mentioned above is as follows.

The radical-polymerizable monomer exhibits excellent characteristics as a photocurable material, but it is known that hydroperoxy radicals are generated as by-products in radical reactions if dissolved oxygen is present in the monomer.

Because these hydroperoxy radicals act as radical polymerization terminators, the radical polymerization reaction is significantly inhibited. As a result, the fixing performance of the liquid developer deteriorates.

In order to suppress this deterioration in fixing performance, an amine compound, which has the function of trapping hydroperoxy radicals, should be added. By adding this compound, it is possible to improve the curability of the radical-polymerizable monomer.

However, in cases where conventional amine compounds that are added to photocurable materials are added to the liquid developer, the volume resistivity of the liquid developer significantly decreases, meaning that the developing performance of the liquid developer deteriorates.

The amine compound contained in the liquid developer of the present invention contains an amino group and at least one group selected from the group consisting of alkyl groups having at least 6 carbon atoms, cycloalkyl groups having at least 6 carbon atoms, alkylene groups having at least 6 carbon atoms and cycloalkylene groups having at least 6 carbon atoms.

In cases where the number of carbon atoms in the alkyl group, cycloalkyl group, alkylene group or cycloalkylene group in the amine compound is at least 6, it is possible to suppress a decrease in the volume resistivity of the liquid developer.

In addition, the amine value of the amine compound is at least 2 mg KOH/g and not more than 200 mg KOH/g.

When the amine value of the amine compound falls within the range mentioned above, it is possible to increase the developing performance of the liquid developer and suppress a decrease in the volume resistivity of the liquid developer.

It is surmised that the amine compound achieves a curability-improving effect while suppressing a decrease in the volume resistivity of the liquid developer because the alkyl groups, cycloalkyl groups, alkylene groups or cycloalkylene groups are present around the amino groups and prevent ionization of the amino groups in the radical-polymerizable monomer.

The radical-polymerizable liquid monomer is not particularly limited as long as the monomer has a high volume resistivity, exhibits electrical insulating properties and is a low viscosity liquid at temperatures close to room temperature. Moreover, the radical-polymerizable liquid monomer acts as a carrier liquid for the liquid developer.

It is possible to use one radical-polymerizable liquid monomer in isolation, or a plurality thereof in combination.

In addition, it is possible to use a non-aqueous solvent other than the radical-polymerizable liquid monomer as long as the effect of the present invention is not impaired. It is possible to use one non-aqueous solvent in isolation, or a plurality thereof in combination.

Moreover, in cases where the carrier liquid is constituted only from the radical-polymerizable liquid monomer, the radical-polymerizable liquid monomer in the liquid developer fulfills the role of a carrier liquid for dispersing toner particles.

Among radical-polymerizable liquid monomers, examples of ultraviolet radiation-curable types include monomers having carbon-carbon double bonds and thiol/ene compositions (mixed compositions comprising polythiol compounds and polyene compounds).

Of these, the radical-polymerizable liquid monomer is preferably a monomer having an acrylic group or methacrylic group.

Specific examples thereof include polymer compounds such as polyethylene glycol diacrylate, polypropylene glycol diacrylate, polyethylene glycol dimethacrylate and polypropylene glycol dimethacrylate; monofunctional or difunctional monomer compounds such as tetrahydrofurfuryl acrylate, 2-hydroxyethyl acrylate, 2-ethylhexyl acrylate, N,N-dimethylacrylamide, 4-hydroxybutyl acrylate, tricyclodecane methacrylate, 2-hydroxyethyl methacrylate, N-vinylpyrrolidone, 1,6-hexane diol diacrylate, 1,9-nonane diol diacrylate, neopentyl glycol diacrylate, diethylene glycol diacrylate, 1,4-butane diol diacrylate and EO-modified bisphenol A diacrylate (M211B available from Toagosei Co., Ltd.); polyfunctional monomers such as pentaerythritol triacrylate, pentaerythritol tetraacrylate (M-450 available from Toagosei Co., Ltd.), dipentaerythritol hexaacrylate and trimethylolpropane triacrylate; and silicone compounds having introduced acrylic groups or methacrylic groups, such as methacrylic-modified silicones and acrylic-modified silicones.

The volume resistivity of the carrier liquid is preferably at least 1.0×10¹⁰ Ω·cm and not more than 1.0×10¹⁴ Ω·cm, and more preferably at least 1.0×10¹⁰ Ω·cm and not more than 1.0×10¹³ Ω·cm.

In cases where the carrier liquid is constituted only from the radical-polymerizable liquid monomer, a radical-polymerizable liquid monomer should be used so that the volume resistivity of the carrier liquid falls within the range mentioned above.

A specific example thereof is a method for using a radical-polymerizable liquid monomer having a volume resistivity of at least 1.0×10¹⁰ Ω·cm (for example, polyethylene glycol diacrylate) in isolation.

In addition, in cases where a radical-polymerizable liquid monomer having a volume resistivity of less than 1.0×10¹⁰ Ω·cm is used in a state whereby the carrier liquid is constituted from radical-polymerizable liquid monomers in isolation, the volume resistivity of the overall carrier liquid should be made to fall within the range mentioned above by additionally using a radical-polymerizable liquid monomer having a volume resistivity of at least 1.0×10¹⁰ Ω·cm and adjusting the mixing proportions of the liquid monomers.

A specific example thereof is a carrier liquid obtained by using 1,9-nonane diol dimethacrylate and lauryl methacrylate and adjusting the mixing proportions thereof so that the volume resistivity of the overall carrier liquid falls within the range mentioned above.

The curable liquid developer contains a photopolymerization initiator that initiates the curing reaction of the radical-polymerizable liquid monomer.

Examples of the photopolymerization initiator include benzophenone, benzoin isobutyl ether, benzoin ethyl ether, methyl benzoylbenzoate, 4-chlorobenzophenone, 4-phenylbenzophenone, 4p-trithiobenzophenone, 2-hydroxy-2,2-dimethylacetophenone, 2,2-diethoxyacetophenone, 2,4,6-trimethylbenzoylphenylethoxy phosphine oxide, Lucirin TPO and Lucirin TPO-L, Irgacure 1850, Irgacure 1700, Irgacure 819 and Irgacure 369 available from BASF SE.

It is possible to use one of these photopolymerization initiators in isolation or a combination of two or more types thereof.

The content of the photopolymerization initiator is not particularly limited, but is preferably at least 0.01 parts by mass and not more than 5.00 parts by mass, more preferably at least 0.05 parts by mass and not more than 2.00 parts by mass, and further preferably at least 0.10 parts by mass and not more than 1.00 parts by mass, relative to 100 parts by mass of the radical-polymerizable liquid monomer.

When the content of the photopolymerization initiator is at least 0.01 parts by mass, it is possible to further improve the fixing performance of the liquid developer, and when the content of the photopolymerization initiator is not more than 5.00 parts by mass, it is possible to further improve the developing performance of the liquid developer.

The curable liquid developer contains a toner particle that is insoluble in the radical-polymerizable liquid monomer.

In addition, the toner particle preferably contains a binder resin and a colorant.

The binder resin contained in the toner particle can be a publicly known binder resin as long as the binder resin exhibits fixing performance on an adherend such as a paper or plastic film and is insoluble in the radical-polymerizable liquid monomer.

Here, if the quantity of dissolved toner particle component or binder resin is not more than 1 part by mass relative to 100 parts by mass of the radical-polymerizable liquid monomer at 25° C., this is an indicator that the toner particle is insoluble in the radical-polymerizable liquid monomer.

Specific examples of the binder resin include vinyl resins, polyester resins, polyurethane resins, epoxy resins, polyamide resins, polyimide resins, silicone resins, phenol resins, melamine resins, urea resins, aniline resins, ionomer resins and polycarbonate resins.

Of these, vinyl resins, polyester resins, polyurethane resins and epoxy resins are preferred, and polyester resins and vinyl resins are more preferred.

Moreover, examples of vinyl resins include methacrylic resins, acrylic resins, styrene-acrylic resins, styrene-methacrylic resins, polyethylene resins, ethylene-methacrylic resins and ethylene-acrylic resins.

It is possible to use one of these resins in isolation or a combination of two or more types thereof.

The acid value of the binder resin is preferably at least 5 mg KOH/g.

When the acid value is at least 5 mg KOH/g, amino groups in the amine compound bond to acid groups in the binder resin and it is possible to increase the volume resistivity of the liquid developer.

This acid value is preferably at least 5 mg KOH/g and not more than 100 mg KOH/g, and more preferably at least 5 mg KOH/g and not more than 50 mg KOH/g.

In addition, in cases where the binder resin is a vinyl resin, the acid value of the binder resin can be controlled by using acrylic acid or methacrylic acid as a constituent component of the vinyl resin and adjusting the molar ratio of monomer units derived from acrylic acid or methacrylic acid relative to the total amount of monomer units that constitute the vinyl resin.

In addition, in cases where the binder resin is a polyester resin, the acid value of the binder resin can be controlled by adjusting the number of terminal groups and the number of carboxylic acid groups relative to the number of terminal groups.

The SP value of the binder resin is preferably at least 9.0 and not more than 15.0, and more preferably at least 9.5 and not more than 13.0.

The SP value is a value determined by calculating using the evaporation energy and molar volume of atoms and atomic groups by Fedors disclosed in Coating Basics and Engineering (page 53, Yuji HARAZAKI, Converting Technical Institute). Units for the SP value are (cal/cm³)^{1/2}, but these can be converted into units of (J/m³)^{1/2} because 1 (cal/cm³)^{1/2}=2.046×10³ (j/m³)^{1/2}.

The polyester resin is not particularly limited, but is preferably a condensation polymerization product of a diol and a dicarboxylic acid. In addition, it is possible to use monohydric or trihydric or higher alcohols and carboxylic acids in order to adjust the acid value or SP value.

Examples of diols include butane diol, pentane diol, hexane diol, heptane diol, octane diol, nonane diol, decane diol, neopentyl glycol, 1,4-butene diol, 1,4-cyclohexane dimethanol, and ethylene oxide adducts and/or propylene oxide adducts of bisphenol A.

Examples of monohydric alcohols include n-butanol, isobutanol, sec-butanol, n-hexanol, n-octanol, lauryl alcohol, 2-ethylhexanol, decanol, cyclohexanol, benzyl alcohol and dodecyl alcohol.

Examples of trihydric or higher alcohols include aromatic alcohols such as 1,3,5-trihydroxymethylbenzene; and aliphatic alcohols such as pentaerythritol, dipentaerythritol, tripentaerythritol, 1,2,4-butane triol, 1,2,5-pentane triol, glycerin, 2-methylpropane triol, 2-methyl-1,2,4-butane triol, trimethylolethane and trimethylolpropane.

Examples of dicarboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, and anhydrides and lower alkyl esters of these acids.

Examples of monohydric carboxylic acids include monocarboxylic acids such as benzoic acid, naphthalenecarboxylic acid, salicylic acid, 4-methylbenzoic acid, 3-methylbenzoic acid, phenoxyacetic acid, biphenylcarboxylic acid, acetic acid, propionic acid, butyric acid, octanoic acid, decanoic acid, dodecanoic acid and stearic acid.

Examples of trihydric or higher carboxylic acids include aromatic carboxylic acids such as 1,2,4-benzenetricarboxylic acid (trimellitic acid), 2,5,7-naphthalenetricarboxylic acid, 1,2,4-naphthalenetricarboxylic acid and pyromellitic acid; aliphatic carboxylic acids such as 1,2,4-butanetricarboxylic acid, 1,2,5-hexanetricarboxylic acid and 1,3-dicarboxyl-2-methyl-2-methylenecarboxypropane; and anhydrides and lower alkyl esters of these acids.

Examples of monomers that constitute vinyl resins include styrene, methacrylic acid, acrylic acid, methyl methacrylate, methyl acrylate, butyl methacrylate and butyl acrylate.

Colorants contained in the toner particles are not particularly limited, and examples thereof include publicly known organic pigments and inorganic pigments.

Specific examples of these pigments include the following pigments as yellow pigments.

C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C. I. Vat Yellow 1, 3 and 20.

Examples of red or magenta pigments include the following.

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238 and 269; C. I. Pigment Violet 19; and C. I. Vat Red 1, 2, 10, 13, 15, 23, 29 and 35.

Examples of blue or cyan pigments include the following.

C. I. Pigment Blue 2, 3, 15:2, 15:3, 15:4, 16 and 17; C. I. Vat Blue 6; C. I. Acid Blue 45, and copper phthalocyanine pigments in which 1-5 phthalimidomethyl groups in the phthalocyanine skeleton are substituted.

Examples of green pigments include the following.

C. I. Pigment Green 7, 8 and 36.

Examples of orange pigments include the following.

C. I. Pigment Orange 66 and 51.

Examples of black pigments include the following.

Carbon black, titanium black and aniline black.

Specific examples of white pigments include the following.

Basic lead carbonate, zinc oxide, titanium oxide and strontium titanate.

Pigment dispersion can be carried out using a dispersing apparatus such as a ball mill, a sand mill, an attritor, a roller mill, a jet mill, a homogenizer, a paint shaker, a kneader, an agitator, a Henschel mixer, a colloid mill, and ultrasonic homogenizer, a pearl mill or a wet jet mill.

It is possible to add a pigment dispersing agent when dispersing the pigment.

Examples of pigment dispersing agents include hydroxyl group-containing carboxylic acid esters, salts of long chain polyaminoamides and high molecular weight acid esters, salts of high molecular weight polycarboxylic acids, high molecular weight unsaturated acid esters, high molecular weight copolymers, modified polyacrylates, aliphatic polycarboxylic acids, condensates of formalin and naphthalenesulfonic acid, polyoxyethylene alkyl phosphate esters and pigment derivatives. In addition, it is also preferable to use a commercially available pigment dispersing agent such as the Solsperse series available from The Lubrizol Corporation.

In addition, it is also possible to use a synergist as a pigment dispersing aid, depending on the type of pigment.

The added quantity of pigment dispersing agent and pigment dispersing aid is preferably at least 1 part by mass and not more than 100 parts by mass relative to 100 parts by mass of pigment.

The content of the colorant is preferably at least 1 part by mass and not more than 100 parts by mass, and more preferably at least 5 parts by mass and not more than 50 parts by mass, relative to 100 parts by mass of the binder resin.

The amine compound contains an amino group and at least one group selected from the group consisting of alkyl groups having at least 6 carbon atoms, cycloalkyl groups having at least 6 carbon atoms, alkylene groups having at least 6 carbon atoms and cycloalkylene groups having at least 6 carbon atoms.

The amino group in the amine compound is not particularly limited, and may be a primary amino group, a secondary amino group or a tertiary amino group, but a primary amino group is preferred.

It is possible to incorporate one alkyl group having at least 6 carbon atoms, cycloalkyl group having at least 6 carbon atoms, alkylene group having at least 6 carbon atoms or cycloalkylene group having at least 6 carbon atoms in isolation, or a combination of a plurality of such groups. Of these, the amine compound preferably contains an alkyl group having at least 6 carbon atoms or a cycloalkyl group having at least 6 carbon atoms, and more preferably contains an alkyl group having at least 6 carbon atoms.

In addition, the amine compound is preferably a polymer that contains a monomer unit having an amino group and a monomer unit having at least one group selected from the group consisting of alkyl groups having at least 6 carbon atoms, cycloalkyl groups having at least 6 carbon atoms, alkylene groups having at least 6 carbon atoms and cycloalkylene groups having at least 6 carbon atoms.

By forming such a structure, the developing performance of the curable developer can be readily improved and a decrease in volume resistivity can be readily suppressed.

When the mass number of the monomer unit having an amino group (hereinafter referred to as monomer unit X) in the amine compound is denoted by X and the mass number of the monomer unit having at least one group selected from the group consisting of alkyl groups having at least carbon atoms, cycloalkyl groups having at least 6 carbon atoms, alkylene groups having at least 6 carbon atoms and cycloalkylene groups having at least 6 carbon atoms (hereinafter referred to as monomer unit Y) is denoted by Y, the X:Y mass ratio is preferably 0.5:99.5 to 70:30, and more preferably 1:99 to 60:40.

In cases where the X:Y mass ratio falls within the range mentioned above, affinity of the amine compound for the radical-polymerizable liquid monomer and the dispersion stability of the toner particles are further improved.

The content of the amine compound is preferably at least 0.005 parts by mass and not more than 2.000 parts by mass, more preferably at least 0.010 parts by mass and not more than 1.200 parts by mass, and further preferably at least 0.010 parts by mass and not more than 1.000 parts by mass, relative to 100 parts by mass of the radical-polymerizable liquid monomer.

In cases where the content of the amine compound falls within the range mentioned above, the developing performance and fixing performance of the curable liquid developer can be further improved.

In addition, the content of the amine compound is preferably at least 1 part by mass and not more than 100 parts by mass relative to 100 parts by mass of the toner particles.

The monomer unit having an amino group is not particularly limited, but is preferably a monomer unit represented by formula (1) below from the perspective of the dispersion stability of the toner particles.

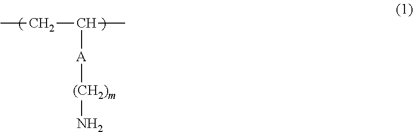

[In formula (1), A denotes a single bond, an alkylene group having 1-6 carbon atoms (and preferably 1-3 carbon atoms) or a phenylene group, and m denotes an integer of 0 to 3.]

The monomer unit having an amino group is more preferably a monomer unit represented by formula (2) below.

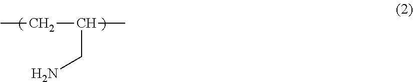

In addition, from the perspective of developing performance, it is preferable for the amine compound to contain a monomer unit having at least one group selected from the group consisting of alkyl groups having at least 6 carbon atoms, cycloalkyl groups having at least 6 carbon atoms, alkylene groups having at least 6 carbon atoms and cycloalkylene groups having at least 6 carbon atoms.

Here, the number of carbon atoms in the alkyl group, cycloalkyl group, alkylene group or cycloalkylene group is at least preferably 12. The upper limit for the number of carbon atoms is preferably not more than 30, and more preferably not more than 22. In addition, at least one hydrogen atom in the alkyl group, cycloalkyl group, alkylene group or cycloalkylene group may be substituted.

Substituent groups able to be present in the alkyl group, cycloalkyl group, alkylene group or cycloalkylene group are not particularly limited, and examples of these substituent groups include alkyl groups, alkoxy groups, halogen atoms, amino groups, hydroxy groups, carboxy groups, carboxylic acid ester groups and carboxylic acid amide groups.

From the perspectives of improving the developing performance of the curable liquid developer and facilitating production of the curable liquid developer, the monomer unit having at least one group selected from the group consisting of alkyl groups having at least 6 carbon atoms, cycloalkyl groups having at least 6 carbon atoms, alkylene groups having at least 6 carbon atoms and cycloalkylene groups having at least 6 carbon atoms is preferably a monomer unit represented by formula (3) below.

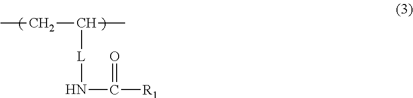

[In formula (3), R₁ denotes an optionally substituted alkyl group having at least 6 carbon atoms or an optionally substituted cycloalkyl group having at least 6 carbon atoms, and L denotes a divalent linking group.]

R₁ means an alkyl group or cycloalkyl group, which is a straight chain group represented by —CₙH₂ₙ₊₁ or a cyclic group represented by —CₙH₂ₙ₋₁, with n being at least 6.

It is more preferable for n to be at least 12. Meanwhile, the upper limit for the value of n is preferably not more than 30, and more preferably not more than 22.

In addition, substituent groups able to be present in R₁ are not particularly limited, and examples of these substituent groups include alkyl groups, alkoxy groups, halogen atoms, amino groups, hydroxy groups, carboxy groups, carboxylic acid ester groups and carboxylic acid amide groups.

L denotes a divalent linking group, and is preferably an alkylene group having 1-6 carbon atoms (and more preferably an alkylene group having 1-3 carbon atoms), an alkenylene group having 1-6 carbon atoms (and more preferably an alkenylene group having 1-3 carbon atoms), or an arylene group having 6-10 carbon atoms.

The amine compound should be contained in the curable liquid developer, but may be present in the toner particles. In such cases, a decrease in the volume resistivity of the liquid developer can be better suppressed.

The amine value of the amine compound is at least 2 mg KOH/g and not more than 200 mg KOH/g. In addition, the amine value is preferably at least 3 mg KOH/g and not more than 190 mg KOH/g, and more preferably at least 5 mg KOH/g and not more than 50 mg KOH/g.

In cases where the amine value of the amine compound falls within the range mentioned above, the dispersion stability, fixing performance and developing performance of the toner particles are excellent.

In cases where the amine value is at least 2 mg KOH/g, the quantity of amino groups is sufficient and a sufficient curability-accelerating effect can be achieved. Meanwhile, in cases where the amine value is not more than 200 mg KOH/g, a decrease in the volume resistivity of the liquid developer can be suppressed.

For example, in cases where the amine compound is a polymer, the amine value can be controlled by adjusting the molar ratio of the monomer unit having an amino group and the monomer unit having at least one group selected from the group consisting of alkyl groups having at least carbon atoms, cycloalkyl groups having at least 6 carbon atoms, alkylene groups having at least 6 carbon atoms and cycloalkylene groups having at last 6 carbon atoms.

The number average molecular weight of the amine compound is preferably not more than 40,000, and more preferably not more than 30,000. When the number average molecular weight falls within the range mentioned above, the dispersion stability of the toner particles can be further improved.

In addition, the number average molecular weight of the amine compound is preferably at least 1000, and more preferably at least 5000.

The curable liquid developer may, if necessary, contain a charge control agent. A publicly known charge control agent may be used.

Examples of specific compounds include the following.

Oils such as linseed oil and soy bean oil; alkyd resins, halogenated polymers, aromatic polycarboxylic acids, acidic group-containing water-soluble dyes, oxidation condensates of aromatic polyamines, metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate and cobalt 2-ethylhexanoate; metal sulfonate salts such as petroleum-based metal sulfonate salts and metal salts of sulfosuccinate esters; phospholipids such as lecithin and hydrogenated lecithin; metal salicylate salts such as metal t-butylsalicylate complexes; polyvinylpyrrolidone resins, polyamide resins, sulfonic acid-containing resins and hydroxybenzoic acid derivatives.

The toner particles may, if necessary, contain a charge adjuvant in order to adjust the charging performance of the toner particles. A publicly known charge adjuvant may be used.

Examples of specific compounds include metal soaps such as zirconium naphthenate, cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, aluminum tristearate and cobalt 2-ethylhexanoate; metal sulfonate salts such as petroleum-based metal sulfonate salts and metal salts of sulfosuccinate esters; phospholipids such as lecithin and hydrogenated lecithin; metal salicylate salts such as metal t-butylsalicylate complexes; polyvinylpyrrolidone resins, polyamide resins, sulfonic acid-containing resins and hydroxybenzoic acid derivatives.

In addition to the components mentioned above, the curable liquid developer may, if necessary, contain a variety of publicly known additives in order to improve recording medium compatibility, storage stability, image storability and other properties. Examples thereof include polymerization inhibitors, surfactants, lubricants, fillers, anti-foaming agents, ultraviolet radiation absorbers, antioxidants, fading inhibitors, anti-fungal agents and rust inhibitors, and these can be selected and used as appropriate.

The method for producing the curable liquid developer is not particularly limited, and examples thereof include publicly known methods such as coacervation methods and wet pulverization methods.

A typical production method comprises mixing a colorant, a binder resin, other additives and a dispersion medium, and pulverizing by means of a bead mill or the like so as to obtain a dispersion of toner particles. An example of a production method is one in which a curable liquid developer is obtained by mixing the obtained dispersion of toner particles, a photopolymerization initiator, a radical-polymerizable monomer, and the like.

Coacervation methods are disclosed in detail in, for example, Japanese Unexamined Patent Application Publication No. 2003-241439, WO 2007/000974 and WO 2007/000975.

In a coacervation method, pigment-encapsulating toner particles can be dispersed in a solvent in which the resin does not dissolve by mixing a pigment, a resin, a solvent that dissolves the resin and a solvent that does not dissolve the resin, removing the solvent that dissolves the resin from the mixed liquid, and precipitating the resin that was in a dissolved state.

Meanwhile, wet pulverization methods are disclosed in detail in, for example, WO 2006/126566 and WO 2007/108485.

In a wet pulverization method, toner particles can be dispersed in an electrically insulating medium by kneading a pigment and a binder resin at a temperature that is not lower than the melting point of the binder resin, dry grinding, and then wet grinding the obtained ground product in an electrically insulating medium.

This type of publicly known method can be used in the present invention.

From the perspective of obtaining high-resolution images, the volume average particle diameter of the toner particles is preferably at least 0.05 μm and not more than 5 μm, and more preferably at least 0.05 μm and not more than 1 μM.

In addition, the concentration of toner particles in the curable liquid developer is not particularly limited, but should be about at least 1 mass % and not more than 70 mass %, preferably about at least 1 mass % and not more than 50 mass %, and more preferably about at least 2 mass % and not more than 40 mass %.

It is preferable for the curable liquid developer to be used after being prepared so as to have physical properties such as those shown below. That is, from the perspective of being able to achieve an appropriate degree of electrophoretic mobility, it is preferable for the viscosity of the curable liquid developer at 25° C. to be at least 0.5 mPa·s and not more than 100 mPa·s in cases where the concentration of toner particles is approximately 2 mass %.

In addition, from the perspective of not lowering the electrostatic latent image potential, the volume resistivity of the curable liquid developer is preferably at least 1×10⁹ Ω·cm and not more than 1×10¹⁵ Ω·cm, and more preferably at least 1×10¹⁰ Ω·cm and not more than 1×10¹³ Ω·cm.

The curable liquid developer can be advantageously used in an ordinary image forming apparatus that uses an electrophotography system.

Methods for curing the liquid developer include methods involving ultraviolet radiation and methods involving an electron beam (EB).

In a curing method involving the use of ultraviolet radiation, the liquid developer is transferred to a recording medium and then rapidly irradiated with ultraviolet radiation so as to cure the developer, thereby fixing an image.

Here, a mercury lamp, a metal halide lamp, an excimer laser, an ultraviolet radiation laser, a cold cathode tube, a hot cathode tube, a black light, a light-emitting diode (LED), or the like, can be used as the light source for irradiating ultraviolet radiation. Of these, a strip-like metal halide lamp, a cold cathode tube, a hot cathode tube, a mercury lamp, a black light or an LED is preferred.

The ultraviolet radiation dose is preferably 0.1 to 1000 mJ/cm², and is more preferably 0.1 to 500 mJ/cm² in cases where energy savings are to be made by the image forming apparatus.

In addition, in a curing method involving the use of ultraviolet radiation, a combination of thermal fixing and ultraviolet radiation fixing may be used. The thermal fixing method may be hot roller fixing, back surface fixing, hot air fixing, or the like, and is not particularly limited.

Measurement methods used in the present invention will now be explained.

### Method for Measuring Volume Resistivity

Using a R8340A digital super-high resistance/microammeter (available from Advantest Corporation), volume resistivity is measured by placing 25 mL of a sample in a liquid sample electrode SME-8330 (available from Hioki E.E. Corporation), and applying a direct current voltage of 1000 V at room temperature (25° C.)

Determination of Structures of Compounds and the Like

Structures of compounds and the like are determined using the following method.

Using an ECA-400 (400 MHz) available from JEOL Ltd., ¹H-NMR and ¹³C-NMR spectral measurements are carried out.

Measurements are carried out at 25° C. in a tetramethylsilane-containing deuterated solvent as a standard substance. Chemical shift values are shown as ppm shift values (δ values), with the shift value of the tetramethylsilane standard substance being 0.

Method for Measuring Amine Value

Basic operations when measuring the amine value are based on ASTM D2074.

Specifically, the following method is used.

(1) 0.5 to 2.0 g of a sample is accurately weighed out. The mass at this point is recorded as M (g).
(2) The sample is placed in a 50 mL beaker, and 25 mL of a tetrahydrofuran/ethanol (3/1) mixed liquid is added so as to dissolve the sample.
(3) Using a 0.1 mol/L ethanol solution of HCl, titration is carried out using a potentiometric titration measurement apparatus (a “COM-2500” automatic titration measurement apparatus available from Hiranuma Sangyo Co., Ltd.).
(4) The usage quantity of the HCl solution at this point is recorded as S (mL). A blank was measured at the same time, and the usage quantity over the HCl solution at this point is recorded as B (mL).
(5) The amine value is calculated from the following formula. f is the factor of the HCl solution.

Amine value [mg KOH/g]={(S−B)×f×5.61}/M

### EXAMPLES

The present invention will now be explained in greater detail through the use of examples, but is not limited to these examples. Moreover, “parts” and “%” mean “parts by mass” and “mass %” respectively, unless explicitly stated otherwise.

### Production Example of Amine Compound (A-1)

An amine compound (A-1) having a structure represented by formula (4) below was produced using the production method shown below.

Moreover, in the formula below, x and y denote mass ratios, and x:y=15:85 in amine compound (A-1).

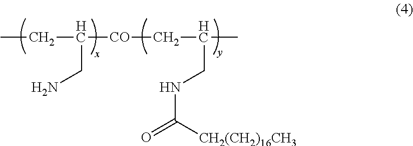

First, 100 parts of propylene glycol monomethyl ether was heated while performing nitrogen substitution, and reflexed at a liquid temperature of at least 120° C.

A mixture obtained by mixing 15 parts of a monomer represented by formula (a-1) below, 85 parts of a monomer represented by formula (a-2) below and 1.0 parts of tert-butyl peroxybenzoate (an organic peroxide-based polymerization initiator, product name: Perbutyl Z, available from NOF Corporation) was added dropwise to the propylene glycol monomethyl ether over a period of 3 hours.

Following completion of the dropwise addition, the solution was stirred for 3 hours, after which atmospheric distillation was carried out while heating to a liquid temperature of 170° C. Once the liquid temperature reached 170° C., the solvent was removed by distilling at a reduced pressure of 1 hPa for 1 hour, thereby obtaining amine compound (A-1).

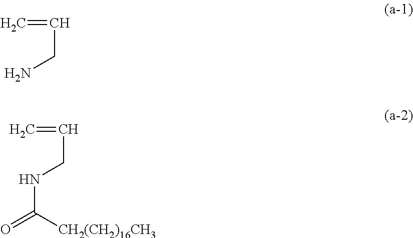

The amine value of obtained amine compound (A-1) was 40 mg KOH/g.

### Production Examples of Amine Compounds (A-2) to (A-4)>

Amine compounds (A-2) to (A-4) were produced using the same method as that used in the production example of amine compound (A-1), except that the mass ratios of the monomer represented by formula (a-1) and the monomer represented by formula (a-2) were altered in the manner shown in Table 1 below.

TABLE 1

| Amine | x | y |
|---|---|---|
| compound | (parts) | (parts) |
| A-1 | 15 | 85 |
| A-2 | 1 | 99 |
| A-3 | 60 | 40 |
| A-4 | 0.3 | 99.7 |

The amine values of obtained amine compounds (A-2) to (A-4) were as follows.

Amine compound (A-2): 3 mg KOH/g

Amine compound (A-3): 190 mg KOH/g

Amine compound (A-4): 1 mg KOH/g

1,9-nonane diol diacrylate, 1,9-nonane diol dimethacrylate or a silicone compound synthesized using the method shown below was used as the radical-polymerizable liquid monomer.

### Synthesis Example of Silicone Compound (S)

178 parts of octamethylcyclotetrasiloxane (D4, available from Tokyo Chemical Industry Co., Ltd.), 23.45 parts of hexavinyldisiloxane (available from AZmax.co) and 0.20 parts of trifluoromethanesulfonic acid were added to a 500 mL container fitted with a stirrer, a temperature gauge, a reflux cooler and a nitrogen inlet tube. The temperature was increased to 80° C. while stirring the mixture in a nitrogen stream. After allowing a reaction to continue for 12 hours, the container was cooled to room temperature, ether was added, and the ether phase was washed with water so as to remove the catalyst.

Next, silicone compound (S) was obtained by removing low molecular weight by-products by heating under reduced pressure. Silicone compound (S) was a polydimethylsiloxane having terminal trivinyl groups.

### Production Example of Toner Particle Dispersion Liquid (T-1)

25 parts of Nucrel N1525 (an ethylene-methacrylic acid resin, available from DuPont-Mitsui Polychemicals CO., LTD) and 75 parts of 1,9-nonane diol diacrylate were placed in a separable flask, and the temperature was increased to 130° C. in an oil bath over a period of 1 hour while stirring at 200 rpm using a three one motor.

A binder resin dispersion liquid was produced by holding at a temperature of 130° C. for 1 hour and then gradually cooling at a temperature decrease rate of 15° C./hour. The obtained binder resin dispersion liquid was a white paste.

A toner particle dispersion (solid content 20 mass %) was obtained by filling 45.54 parts of the binder resin dispersion liquid, Pigment Blue 15:3 (3.42 parts) as a pigment, 0.20 parts of aluminum tristearate as a charge adjuvant, 5 parts of amine compound (A-1) and 45.84 parts of 1,9-nonane diol diacrylate in a planetary bead mill (Classic Line P-6, available from Fritsch GmbH) together with zirconia beads having diameters of 0.5 mm, and pulverizing for 4 hours at room temperature at 200 rpm.

The volume average particle diameter of the toner particles contained in the obtained toner particle dispersion was 0.85 μm (measured using a dynamic light scattering (DLS) particle size distribution measuring device and a Nanotrac 150 available from MicrotracBEL Corp.).

### Production Examples of Toner Particle Dispersion Liquids (T-2) to (T-15)

Toner particle dispersion liquids (T-2) to (T-15) were produced using the same method as that used in the production example of toner particle dispersion liquid (T-1), except that the amine compound, the added quantity thereof and the 1,9-nonane diol diacrylate were altered in the manner shown in Table 2 below.

TABLE 2

| Toner | | | |
|---|---|---|---|
| particle | Amine compound | | |
| dispersion | | Added | Radical-polymerizable |
| liquid | | quantity | liquid monomer |
| No. | Type | (parts) | Type |
| T-1 | A-1 | 5 | 1,9-nonane diol diacrylate |
| T-2 | A-1 | 5 | 1,9-nonane diol dimethacrylate |
| T-3 | A-1 | 0.1 | 1,9-nonane diol diacrylate |
| T-4 | A-1 | 10 | 1,9-nonane diol diacrylate |
| T-5 | A-1 | 0.07 | 1,9-nonane diol diacrylate |
| T-6 | A-1 | 12 | 1,9-nonane diol diacrylate |
| T-7 | Eicosylamine | 0.07 | 1,9-nonane diol diacrylate |
| T-8 | A-1 | 5 | Silicone compound (S) |
| T-9 | A-2 | 0.07 | 1,9-nonane diol diacrylate |
| T-10 | A-3 | 12 | 1,9-nonane diol diacrylate |
| T-11 | A-4 | 0.07 | 1,9-nonane diol diacrylate |
| T-12 | S13940 | 12 | 1,9-nonane diol diacrylate |
| T-13 | Isoamyl | 12 | 1,9-nonane diol diacrylate |
| | p-dimethyl | | |
| | aminobenzoate | | |
| T-14 | PAA-03 | 5 | 1,9-nonane diol diacrylate |
| T-15 | — | — | 1,9-nonane diol diacrylate |

In Table 2,

S13940 is Solsperse 13940 (a product of a reaction between a polyethylene-polyamine and a self-condensate of 12-hydroxystearic acid, available from The Lubrizol Corporation), and has an amine value of 228 mg KOH/g.

PAA-03 is a polyallylamine available from Nitto Boseki Co., Ltd., and has an amine value of 473 mg KOH/g.

The amine value of eicosylamine is 188 mg KOH/g.

The amine value of isoamyl p-dimethylaminobenzoate is 239 mg KOH/g.

### Production Example of Curable Liquid Developer (D-1)

A curable liquid developer (D-1) was obtained by mixing 9.8 parts of toner particle dispersion liquid (T-1), 0.1 parts of hydrogenated lecithin (Lecinol S-10 available from Nikko Chemicals Co., Ltd.) as a charge control agent, 90.2 parts of 1,9-nonane diol diacrylate as a radical-polymerizable liquid monomer and 0.5 parts of Irgacure 369 (available from BASF Japan Ltd., an α-aminoalkylphenone-based photo-radical polymerization initiator) as a photopolymerization initiator.

### Production Examples of Curable Liquid Developers (D-2) to (D-19)

Curable liquid developers (D-2) to (D-19) were produced using the same method as that used in the production example of curable liquid developer (D-1), except that the type of toner particle dispersing agent, the content of the amine compound, the type of radical-polymerizable liquid monomer and the content of the photopolymerization initiator were altered in the manner shown in Table 3.

TABLE 3

| | Toner | | Photo | |
|---|---|---|---|---|
| Curable | particle | | polymerization | Amine |
| liquid | dispersion | | initiator | compound |
| developer | liquid | Radical-polymerizable | Content | Content |
| No. | No. | liquid monomer | (parts) | (parts) |
| D-1 | T-1 | 1,9-nonane diol diacrylate | 0.50 | 0.500 |
| D-2 | T-2 | 1,9-nonane diol dimethacrylate | 0.50 | 0.500 |
| D-3 | T-3 | 1,9-nonane diol diacrylate | 0.50 | 0.010 |
| D-4 | T-4 | 1,9-nonane diol diacrylate | 0.50 | 1.000 |
| D-5 | T-5 | 1,9-nonane diol diacrylate | 0.50 | 0.007 |
| D-6 | T-6 | 1,9-nonane diol diacrylate | 0.50 | 1.200 |
| D-7 | T-5 | 1,9-nonane diol diacrylate | 0.05 | 0.007 |
| D-8 | T-6 | 1,9-nonane diol diacrylate | 2.00 | 1.200 |
| D-9 | T-5 | 1,9-nonane diol diacrylate | 0.03 | 0.007 |
| D-10 | T-6 | 1,9-nonane diol diacrylate | 4.00 | 1.200 |
| D-11 | T-7 | 1,9-nonane diol diacrylate | 0.03 | 0.007 |
| D-12 | T-8 | Silicone compound (S) | 0.50 | 0.500 |
| D-13 | T-9 | 1,9-nonane diol diacrylate | 0.03 | 0.007 |
| D-14 | T-10 | 1,9-nonane diol diacrylate | 4.00 | 1.200 |
| D-15 | T-11 | 1,9-nonane diol diacrylate | 0.03 | 0.007 |
| D-16 | T-12 | 1,9-nonane diol diacrylate | 4.00 | 1.200 |
| D-17 | T-13 | 1,9-nonane diol diacrylate | 4.00 | 1.200 |
| D-18 | T-14 | 1,9-nonane diol diacrylate | 0.50 | 0.500 |
| D-19 | T-15 | 1,9-nonane diol diacrylate | 0.50 | — |

In Table 3, the content (parts) of the photopolymerization initiator denotes the content (parts by mass) relative to 100 parts by mass of the radical-polymerizable liquid monomer, and the content (parts) of the amine compound denotes the content (parts by mass) relative to 100 parts by mass of the radical-polymerizable liquid monomer.

Curable liquid developers (D-1) to (D-19) were evaluated using the methods shown below.

### Evaluation of Fixing Performance

A curable liquid developer was coated (at a thickness of 8.0 μm) on a poly(ethylene terephthalate) film at a temperature of 25° C. using a wiper bar (No. 6), and irradiated at a light dose of 200 mJ/cm² (measured wavelength 365 nm) by means of a high-pressure mercury lamp having an output of 120 mW/cm², thereby forming a cured film. Immediately after the curing, the film surface was touched by hand and it was confirmed whether or not the film surface exhibited surface tackiness.

Evaluation criteria for fixing performance are as follows.

5: No tackiness whatsoever
3: Slight tackiness
1: Film detached when touched, or curing did not occur

The evaluation results are shown in Table 4.

Evaluation of Developing Performance

An electrostatic pattern was formed on an electrostatic recording paper at a surface charge of 500 V. The electrostatic pattern was developed at a processing speed of 20 mm/sec using a curable liquid developer by means of a roller developing machine having a metal roller. The quality of the obtained image was confirmed visually. Evaluation criteria for developing performance are as follows.

5: A high-density high-resolution image was obtained
4: Slight density variations or slight image blurring was observed
3: Density variations or image blurring was observed in some places, but it was understood that the image had generally been developed well
2: Significant density variations or image blurring occurred, and developing was not satisfactory
1: Developing was not possible

The evaluation results are shown in Table 4.

Evaluation of Dispersion Stability of Toner Particle

10 mL of a curable liquid developer was placed in a test tube (opening diameter 12 mm, length 120 mm), and the depth of sediment (the distance from the liquid surface to the surface formed by sedimentation of the toner particles) was measured after allowing the test tube to stand for 10 days. Evaluation criteria for dispersion stability are as follows.

5: Depth of sediment was 0 mm
4: Depth of sediment was more than 0 mm and not more than 1.5 mm
3: Depth of sediment was more than 1.5 mm and not more than 3 mm
2: Depth of sediment was more than 3 mm and not more than 5 mm
1: Depth of sediment was more than 5 mm

The evaluation results are shown in Table 4.

TABLE 4

| | Curable | | | |
|---|---|---|---|---|
| | liquid | | | |
| | developer | Fixing | Developing | Dispersion |
| | No. | performance | performance | stability |
| Example 1 | D-1 | 5 | 5 | 5 |
| Example 2 | D-2 | 5 | 5 | 5 |
| Example 3 | D-3 | 5 | 5 | 4 |
| Example 4 | D-4 | 5 | 4 | 5 |
| Example 5 | D-5 | 3 | 5 | 3 |
| Example 6 | D-6 | 5 | 4 | 5 |
| Example 7 | D-7 | 3 | 5 | 3 |
| Example 8 | D-8 | 5 | 4 | 4 |
| Example 9 | D-9 | 3 | 5 | 3 |
| Example 10 | D-10 | 5 | 3 | 4 |
| Example 11 | D-11 | 3 | 5 | 3 |
| Example 12 | D-12 | 3 | 4 | 5 |
| Example 13 | D-13 | 3 | 5 | 3 |
| Example 14 | D-14 | 5 | 3 | 4 |
| Comparative | D-15 | 1 | 5 | 2 |
| Example 1 | | | | |
| Comparative | D-16 | 5 | 1 | 3 |
| Example 2 | | | | |
| Comparative | D-17 | 5 | 1 | 3 |
| Example 3 | | | | |
| Comparative | D-18 | 3 | 1 | 2 |
| Example 4 | | | | |
| Comparative | D-19 | 1 | 5 | 1 |
| Example 5 | | | | |

According to the present invention, it is possible to provide a curable liquid developer by which high image density can be achieved, which is unlikely to cause image blurring and which exhibits sufficient fixing performance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-091510 filed May 2, 2017, which is hereby incorporated by reference herein in its entirety.

What is claimed is:

1. A curable liquid developer comprising
a radical-polymerizable liquid monomer,
a photopolymerization initiator,
a toner particle being insoluble in the radical-polymerizable liquid monomer, and
an amine compound,
wherein
the amine compound contains an amino group and at least one group selected from the group consisting of an alkyl group having at least 6 carbon atoms, a cycloalkyl group having at least 6 carbon atoms, an alkylene group having at least 6 carbon atoms and a cycloalkylene group having at least 6 carbon atoms, and
an amine value of the amine compound is at least 2 mg KOH/g and not more than 200 mg KOH/g.

2. The curable liquid developer according to claim 1, wherein the radical-polymerizable liquid monomer has an acrylic group or a methacrylic group.

3. The curable liquid developer according to claim 1, wherein
the amine compound is a polymer containing a monomer unit having an amino group and a monomer unit having at least one group selected from the group consisting of an alkyl group having at least 6 carbon atoms, a cycloalkyl group having at least 6 carbon atoms, an alkylene group having at least 6 carbon atoms and a cycloalkylene group having at least 6 carbon atoms.

4. The curable liquid developer according to claim 3, wherein
when a mass number of the monomer unit having an amino group is denoted by X and
a mass number of the monomer unit having at least one group selected from the group consisting of an alkyl group having at least 6 carbon atoms, a cycloalkyl group having at least 6 carbon atoms, an alkylene group having at least 6 carbon atoms and a cycloalkylene group having at least 6 carbon atoms is denoted by Y,
a X:Y mass ratio is 0.5:99.5 to 70:30.

5. The curable liquid developer according to claim 1, wherein
a content of the photopolymerization initiator is at least 0.05 parts by mass and not more than 2.00 parts by mass relative to 100 parts by mass of the radical-polymerizable liquid monomer.

6. The curable liquid developer according to claim 1, wherein
a content of the amine compound is at least 0.010 parts by mass and not more than 1.000 parts by mass relative to 100 parts by mass of the radical-polymerizable liquid monomer.

7. The curable liquid developer according to claim 1, wherein
the amine compound contains an amino group and an alkyl group having at least 6 carbon atoms.
